(19) United States
(12) Patent Application Publication
(10) Pub. No.: US 2006/0033426 A1
(43) Pub. Date: Feb. 16, 2006

(54) Full-color organic electroluminescence pixel devices and display panel composed of the same device

(76) Inventors: Ching-Ian Chao, Hsinchu (TW); Chia-Kuo Yen, Hsinchu (TW); Chun-Te Lu, Hsinchu (TW); En-Chung Chang, Hsinchu (TW)

Correspondence Address: HARNESS, DICKEY & PIERCE, P.L.C., P.O. BOX 8910, RESTON, VA, 20195, US

(21) Appl. No.: 10/986,795

(22) Filed: Nov. 15, 2004

(30) Foreign Application Priority Data
Aug. 10, 2004 (TW) 93123916

(51) Int. Cl. H05B 33/00

(52) U.S. Cl. 313/504; 313/506

(57) ABSTRACT

A full-color organic electroluminescence (OEL) pixel device and a display panel composed of the OEL pixel device are disclosed. The full-color OEL pixel device is formed by a combination of OEL sub-pixel elements of three types corresponding to R, G and B. The full-color organic OEL pixel device comprises a common electrode, first sub-pixel organic material layers arranged at a surface of mentioned common electrode, a first electrode arranged to sandwich mentioned first sub-pixel organic material layers with mentioned common electrode, second and third sub-pixel organic material layers arranged in parallel at another surface of mentioned common electrode, a second electrode arranged to sandwich mentioned second sub-pixel organic material layers with mentioned common electrode, and a third electrode arranged to sandwich mentioned third sub-pixel organic material layers with mentioned common electrode. An inventive full-color OEL display panel will feature high aperture ratio, high pixel density and low reflection.

### BACKGROUND OF THE INVENTION

1. Field of Invention

The invention relates to an organic electroluminescence (OEL) device, and particularly to a full-color OEL pixel device and display panel composed of the OEL pixel device.

2. Related Art

An organic electroluminescence (OEL) device possesses the advantages of both liquid crystal display (LCD) and inorganic light-emitting diode (LED), such as compact size, high resolution, low power consumption, self-emission and fast response. Thus the OEL device is considered as a promising candidate for the next-generation of flat display panel.

A full-color OEL display is formed by a plurality of pixel devices, each pixel device comprises red, green, blue (RGB) sub-pixels to achieve color, RGB sub-pixels can be carried out by way of RGB direct emission or color conversion. Color conversion may generally classified into white-light sub-pixel with color filter and blue-light sub-pixel with color conversion layer. In the method of using color filter, a white-light OEL device is used in conjunction with color filters to reach the full color capability. This method provides the advantage of directly applying the current color filter technology used in the liquid crystal display (LCD) thereto, and there is no need to use metal mask so that the manufacturing for OEL display will be easier. However, to use color filter will lead to high-power consumption of the display panel and high manufacturing costs. The other color conversion method is to use both color conversion layer and blue or green OEL devices. This method may be seen in, for example, the patents U.S. Pat. No. 5,294,870 and U.S. Pat. No. 6,166,489. In the two patents, a short-wavelength OEL device, such as a blue OEL device or a green OEL device, is used and the short-wavelength light emitted therefrom is conversed into a green or a red light and thus the red, green and blue lights are respectively obtained. Although the method is simpler, the cost in manufacturing and the power consumed in the display panel are relatively higher and the color saturation is also relatively poorer.

As for RGB direct emission, the structure of side-by-side RGB sub-pixel is the most frequently used in the full-color OEL device, in which R, G and B sub-pixels are arranged side by side and form jointly a single pixel in the same plane and the full-color capability is thus achieved. This structure has the advantages of an optimal emission efficiency and a better color rendering index. However, each of the OEL pixel is required to be manufactured by three fine metal masks and three-time precise alignment processes, which is not easy to be controlled. Meanwhile, the gap between each of two adjacent sub-pixels in the corresponding single pixel reduces the aperture ratio of the corresponding pixel.

Therefore, the patent U.S. Pat. No. 5,917,280 discloses a stacked OEL device, in which R, G and B OEL devices are vertically stacked one by one to generate the full color capacity. However, the lights emitted from the OEL devices at the top and the second top of the stacked structure need to penetrate through a plurality of electrodes and a plurality sets of organic material layers arranged in the stacked structure, which reduces the emission efficiency and simultaneously leads to a color shift due to microcavity effect. Also, the manufacturing process for the stacked OEL device is too complex to be carried out in mass production.

In addition, the back electrode of the traditional OEL device is a metal layer and the reflectance of an ambient light caused thereby will lead to a considerably reduced contrast of the OEL panel and thus poor image quality. In this case, both optical absorption and optically destructive interference are used to reduce such reflectance. For example, the patents U.S. Pat. No. 6,411,019 and U.S. Pat. No. 6,545,409 disclosed an OEL device, in which a semi-transparent optical interference member adjacent to the back electrode is disposed in the device; the reflectance of the OEL panel may be reduced through the optical absorption and the optically destructive interference.

### SUMMARY OF THE INVENTION

In view of the shortcomings encountered in the prior arts, the invention provides a full-color OEL pixel device and a full-color OEL display panel composed of a plurality of the full-color OEL pixel devices aforementioned, in which R, G, and B three sub-pixel devices are integrated into the OEL pixel device to achieve full-color capability, so that the aperture ratio of the full-color OEL display panel is increased and the reflectance is reduced.

The full-color OEL pixel device according to the invention having R, G and B sub-pixel devices combined therein as a pixel and comprises a common electrode, first sub-pixel organic material layers arranged at a surface of mentioned common electrode, a first electrode arranged to sandwich mentioned first sub-pixel organic material layers with mentioned common electrode, second and third sub-pixel organic materials layers arranged in parallel at another surface of mentioned common electrode, a second electrode arranged to sandwich said second sub-pixel organic material layers with mentioned common electrode, and a third electrode arranged to sandwich mentioned third sub-pixel organic material layers with mentioned common electrode. Further, the full-color OEL pixel device may be subject to some suitable modifications in structure without violating the principle of the device structure.

As compared to the prior art in which RGB sub-pixel devices forming a pixel device are arranged side by side, the full-color OEL pixel device according to the invention also has three sub-pixel devices to form a pixel device, two of them arranged side by side and the other one arranged over the two sub-pixel devices based on the same pixel area as that of the pixel device in the prior art. In the prior art, each sub-pixel device in the composed pixel device has an area approximately one-third of the pixel area. However, in the sub-pixel device according to the invention, each of the second and third sub-pixel devices has an area approximately half the area of the pixel and the first sub-pixel device is almost the same as the area of the composed pixel device, which features a significantly higher aperture ratio. Compared to the prior art, the pixel device according to the invention can be reduced to two third of the width of the full-color pixel device according to the prior RGB side-by-side structure, based on the same-width opening metal mask in manufacturing a display panel. The panel is composed of a plurality of the pixel devices as that used for manufacturing a prior display panel, composed of a plurality of the prior devices. Namely, the dimensions of full-color OEL panel in the invention are reduced to two-third compared to the prior art, which is beneficial to the manufacturing of a high-resolution OEL display panel.

The full-color OEL display panel according to the invention is formed by a plurality of OEL pixel devices according to the invention arranged in a matrix form. The second sub-pixel device of the pixel device abuts the third sub-pixel device of the adjacent pixel device. Or, the second sub-pixel device of the pixel device abuts the second sub-pixel device of the adjacent pixel device.

In addition, the structure in the inventive OEL pixel device or display panel may reduce the reflectance of the ambient light by utilizing the semi-transparent common electrode and the reflective back electrode. If the first electrode is designed as the light-emitting side, the first electrode will be transparent and both the second and the third electrodes are reflective. If the first electrode is designed as the reflective side, the first electrode will be reflective and both the second and the third electrodes are transparent to allow lights to pass. Therefore, the common electrode in the OEL pixel device is used as a semi-reflective controlling layer. Through adjustment of the common electrode and the thickness of organic layers closed to the reflective back electrode, an optically destructive interference may be generated and thus the reflectance of the ambient light may be largely eliminated and the contrast of the image produced on the OEL display panel may be promoted.

The other objects, features and implementations will become apparent through the description below with reference to the accompanying drawings.

### BRIEF DESCRIPTION OF THE DRAWINGS

The invention will become more fully understood from the detailed description given hereinbelow illustration only, and thus doesn't limit the invention, wherein:

FIG. 1 is a schematic structure in a full-color OEL pixel device of the first preferred embodiment according to the invention;

FIG. 2 is a schematic structure in the full-color OEL pixel device of the second preferred embodiment according to the invention;

FIG. 3 is a schematic structure of the OEL display panel composed of the plurality of the inventive full-color OEL pixel device of the third preferred embodiment according to the invention;

FIG. 4 is a schematic structure of the OEL display panel composed of the plurality of the inventive full-color OEL pixel device of the fourth preferred embodiment according to the invention;

FIG. 5 is a schematic structure of the OEL display panel composed of the plurality of the inventive full-color OEL pixel device of the fifth preferred embodiment according to the invention; and

FIG. 6 is a schematic structure of the OEL display panel composed of the plurality of the inventive full-color OEL pixel device of the sixth preferred embodiment according to the invention.

### DETAILED DESCRIPTION OF THE INVENTION

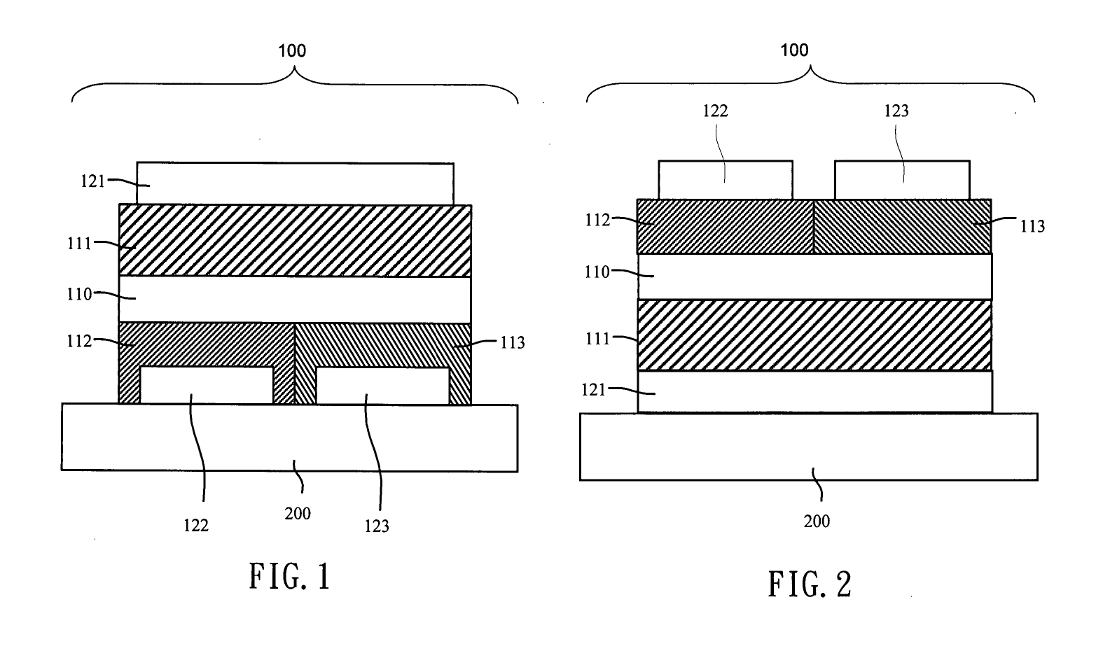

Referring to FIG. 1, a structure of a full-color OEL pixel device of the first embodiment according to the invention is schematically illustrated therein. The full-color OEL pixel device 100 comprises a transparent substrate 200, a common electrode 110, first sub-pixel organic material layers 111, a first electrode 121, second sub-pixel organic material layers 112, a second electrode 122, third sub-pixel organic material layers 113 and a third electrode 123. As shown, the transparent substrate 200 bears the second electrode 122 and the third electrode 123 thereon. The second and third sub-pixel organic material layers 112,113 are arranged adjacently and in parallel and over the second and third electrodes 122,123, respectively. The common electrode 110 is arranged over the second and third sub-pixel organic material layers 112,113. The first sub-pixel organic material layers 111 are arranged over the common electrode 110. And the first electrode 121 is arranged over the first sub-pixel organic materials 111.

Referring to FIG. 2, a structure of the full-color OEL pixel device of a second embodiment according to the invention is schematically illustrated therein. The full-color OEL pixel device 100 comprises a transparent substrate 200, a common electrode 110, first sub-pixel organic material layers 111, a first electrode 121, second sub-pixel organic material layers 112, a second electrode 122, third sub-pixel organic material layers 113 and a third electrode 123. As shown, the transparent substrate 200 bears the first electrode 121 thereon. The first sub-pixel organic material layers 111 are arranged over the first electrode 121. The common electrode 110 is arranged over the first sub-pixel organic material layers 111. The second and third sub-pixel organic material layers 112, 113 are arranged adjacently and in parallel and over the common electrode 110. The second and third electrodes 122,123 are arranged over the second and third sub-pixel organic materials 112,113, respectively.

A plurality of the full-color OEL pixel devices may form a full-color OEL display panel, in which each of the plurality of the full-color OEL pixel devices may be applied as a top-emission or a bottom-emission device according to its arrangement of the internal components when it is bonded to the substrate. And the thus formed display panel may be an active-matrix or a passive-matrix panel.

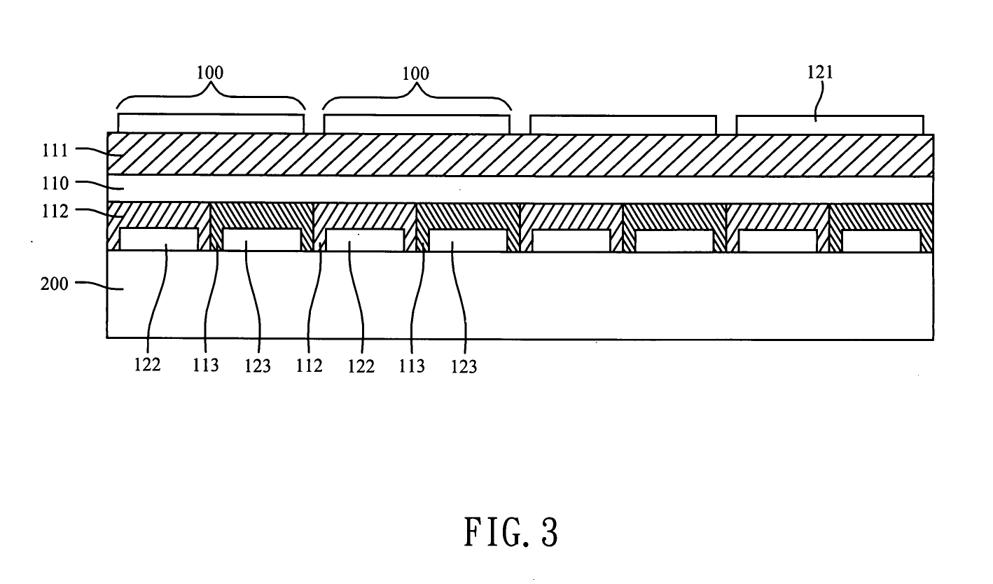

Referring to FIG. 3, a schematic structure of the OEL display panel of the third embodiment formed through a plurality of full-color OEL pixel devices of the first embodiment is provided therein, and the display panel is a bottom-emission OEL display panel. The full-color OEL display panel comprises a plurality of full-color OEL pixel devices 100 arranged in a matrix form. The full-color OEL pixel device 100 is bonded to the transparent substrate 200 with its second and third electrodes 122,123. The second and third electrodes 122, 123 are transparent. The second and third sub-pixels organic material layers 112,113 are arranged adjacently and in parallel and over the second and third electrodes 122,123. The common electrode 110 is arranged over the second and third sub-pixels organic material layers 112,113. The first sub-pixel organic material layers 111 are arranged over the common electrode 110. And the first electrode 121 is arranged over the first sub-pixel organic material layers 111. As shown, the second sub-pixel organic layers 112 in the full-color OEL pixel device 100 abuts the third sub-pixel organic layers 113 in its adjacent the full-color OEL pixel device 100. The third sub-pixel organic layers 113 in the full-color OEL pixel device 100 abuts the second sub-pixel organic layers 112 in its adjacent the full-color OEL pixel device 100. In this embodiment, the device 100 has a light-emitting side closer to the second and third electrodes 122, 123. The first electrode 121 is high optically reflective, while each of the second and third electrodes 122, 123 are optically transparent. In practical, the first electrode 121 may be a metal electrode and each of the second and third electrodes 122,123 may be a transparent electrode, pre-coated on the transparent substrate 200, such as an indium tin oxide (ITO) electrode, an indium zirconium oxide (IZO) electrode and a thin metal electrode.

On the contrary, the full-color OEL display panel may be instead a top-emissiondisplay panel. In this case, a general substrate may be used and the side of the full-color OEL pixel device closer to the first electrode is taken as the light-emitting side of the OEL pixel device. In the OEL pixel device, the first electrode 121 is optically transparent, such as an ITO electrode, an IZO electrode and a thin metal electrode, while each of the second and third electrodes 122,123 is high optically reflective, such as a metal electrode pre-coated on the substrate.

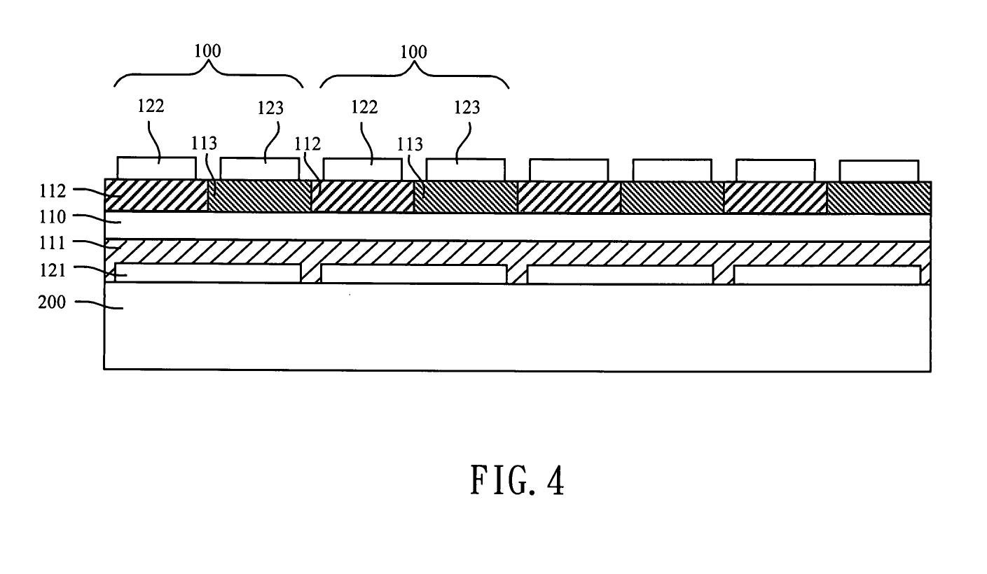

Referring to FIG. 4, a schematic structure of the display panel of a fourth embodiment formed through the plurality of full-color OEL pixel devices of the second embodiment is provided therein, and the display panel is a bottom-emission OEL display panel. The full-color OEL display panel comprises a plurality of full-color OEL pixel devices 100 arranged in a matrix form. The full-color OEL pixel device 100 is bonded to the transparent substrate 200 with its first electrode 121. The first electrode 121 is transparent. The first sub-pixel organic material layers 111 are arranged over the first electrode 121. The common electrode 110 is arranged over the first sub-pixel organic material layers 111. The second and third sub-pixel organic material layers 112, 113 are arranged over the common electrode 110. And the second and third electrodes 122, 123 are arranged adjacently and in parallel and over the second and third organic layers 112, 113. As shown, the second sub-pixel organic layers 112 in the full-color OEL pixel device 100 abuts the third sub-pixel organic layers 113 in its adjacent the full-color OEL pixel device 100. The third sub-pixel organic layers 113 in the full-color OEL pixel device 100 abuts the second sub-pixel organic layers 112 in its adjacent the full-color OEL pixel device 100. In this embodiment, the device 100 has a light-emitting side closer to the first electrode 121. The first electrode 121 is optically transparent, while each of the second and third electrodes 122,123 is high optically reflective. In practical, each of the second and third electrodes 122, 123 may be a metal electrode and the first electrode 121 may be a transparent electrode, pre-coated on the transparent substrate 200, such as an indium tin oxide (ITO) electrode, an indium zirconium oxide (IZO) electrode and a thin metal electrode.

On the contrary, the full-color OEL display panel may be instead a top-emission display panel. In this case, a general substrate may be used and the side of the full-color OEL pixel device closer to the second and third electrodes is taken as the light-emitting side of the OEL pixel device. In the OEL pixel device, the first electrode 121 is high optically reflective, such as a metal electrode pre-coated on the substrate, while each of the second and third electrodes 122,123 is optically transparent, such as an ITO electrode, an IZO electrode and a thin metal electrode.

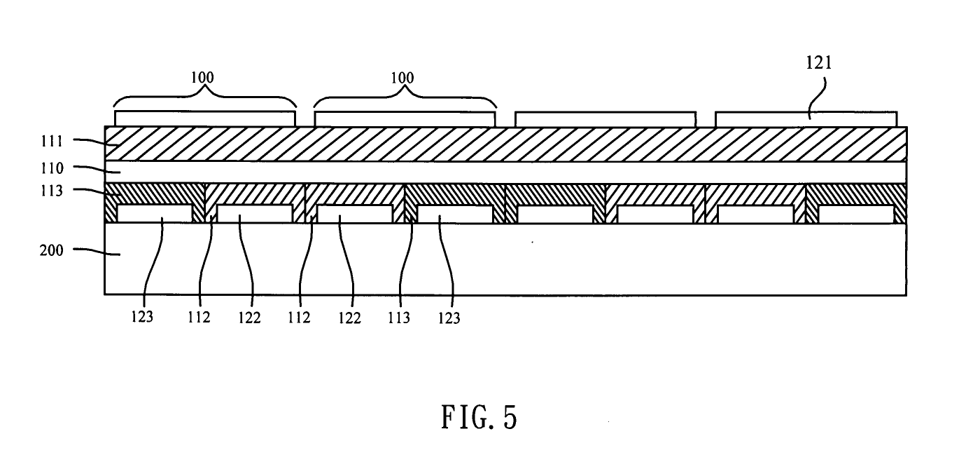

Referring to FIG. 5, a schematic structure of the display panel of a fifth embodiment formed through the plurality of full-color OEL devices of the first embodiment is provided therein. Different from the third embodiment, in this embodiment the second sub-pixel organic layers 112 in the full-color OEL pixel device 100 abuts the second sub-pixel organic layers 112 in its adjacent the full-color OEL pixel device 100. The third sub-pixel organic layers 113 in the full-color OEL pixel device 100 abuts the third sub-pixel organic layers 113 in its adjacent the full-color OEL pixel device 100.

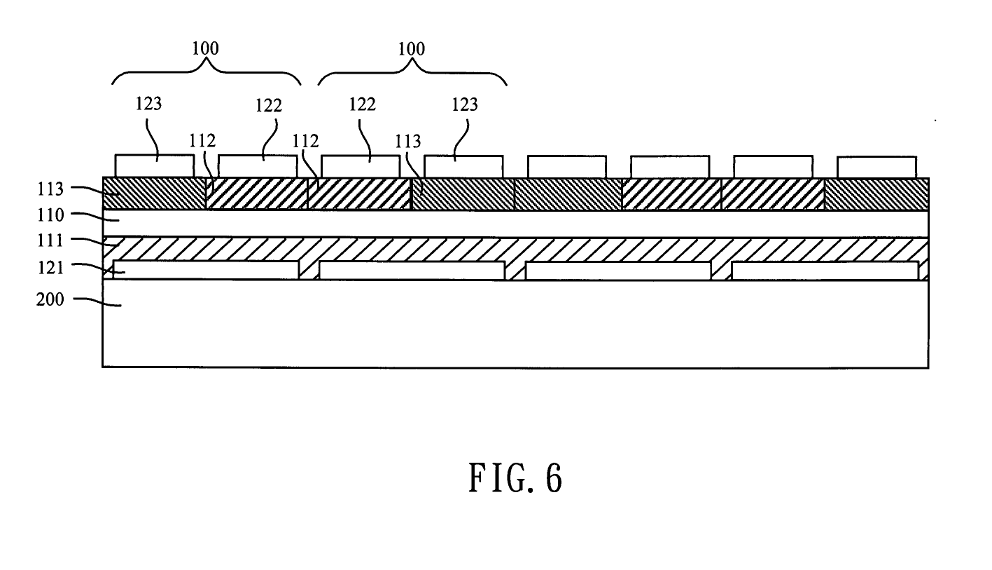

Referring to FIG. 6, a schematic structure of the display panel of the sixth embodiment formed through the plurality of full-color OEL devices of the second embodiment is provided therein. The feature of this embodiment is already described in the fifth and second embodiments and will not be recited here.

As compared with the third and fourth embodiments, the fifth and sixth embodiments provide the advantage that a two-time-pixel-density display panel is obtained in the fifth and sixth embodiments by using a same opening width of metal mask.

According to the invention, the common electrode may be a semi-transparent electrode, which may be a metal, a metal alloy or a metal oxide. Each of the first, second and third sub-pixel organic material layers may be a suitable combination of the elements selected from the group consisting of a hole-injection layer, a hole-transport layer, a light-emission layer, an electron-transport layer and an electron-injection layer. Also, the first, second and third sub-pixel organic material layers generate respectively a light of red, green and blue colors.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A full-color organic electroluminescence (OEL) pixel device, comprises:
a common electrode;
a plurality of first sub-pixel organic material layers arranged at a surface of said common electrode;
a first electrode arranged to sandwich said first sub-pixel organic material layers with said common electrode
a plurality of second sub-pixel organic material layers and a plurality of third sub-pixel organic material layers arranged in parallel at another surface of said common electrode;
a second electrode arranged to sandwich said second sub-pixel organic material layers with said common electrode; and
a third electrode arranged to sandwich said third sub-pixel organic material layers with said common electrode.

2. The full-color OEL pixel device of claim 1, wherein said common electrode is a semi-transparent electrode.

3. The full-color OEL pixel device of claim 1, wherein said common electrode is made of a material selected from a group consisting of a metal, a metal alloy and a metal oxide.

4. The full-color OEL pixel device of claim 1, further comprising a transparent substrate bearing said first electrode thereon.

5. The full-color OEL pixel device of claim 1, further comprising a transparent substrate bearing said second and third electrodes thereon.

6. The full-color OEL pixel device of claim 1, wherein said first electrode is high optically reflective while each of said second and third electrodes is optically transparent.

7. The full-color OEL pixel device of claim 6, wherein said first electrode is a metal electrode while each of said second and third electrodes is a transparent electrode.

8. The full-color OEL pixel device of claim 1, wherein said first electrode is optically transparent while each of said second and third electrodes is high optically reflective.

9. The full-color OEL pixel device of claim 8, wherein said first electrode is a transparent electrode while each of said second and third electrodes is a metal electrode.

10. The full-color OEL pixel device of claim 1, wherein said first sub-pixel organic material layers include a suitable combination of elements selected from the group consisting of a hole-injection layer, a hole-transport layer, a light-emission layer, an electron-transport layer and an electron-injection layer.

11. The full-color OEL pixel device of claim 1, wherein said second sub-pixel organic material layers include a suitable combination of elements selected from the group consisting of a hole-injection layer, a hole-transport layer, a light-emission layer, an electron-transport layer and an electron-injection layer.

12. The full-color OEL pixel device of claim 1, wherein said third sub-pixel organic material layers include a suitable combination of elements selected from the group consisting of a hole-injection layer, a hole-transport layer, a light-emission layer, an electron-transport layer and an electron-injection layer.

13. The full-color OEL pixel device of claim 1, wherein said first, second and third sub-pixel organic material layers generate a red light, a green light and a blue light, respectively.

14. A full-color organic electroluminescence (OEL) display panel, comprising:
a plurality of full-color OEL pixel devices arranged in a matrix and corresponding to a plurality of pixels as a display screen, each of said plurality full-color OEL pixel devices, comprising:
a common electrode;
a plurality of first sub-pixel organic material layers arranged at a surface of said common electrode;
a first electrode arranged to sandwich said first sub-pixel organic material layers with said common electrode
a plurality of second sub-pixel organic material layers and a plurality of third sub-pixel organic material layers arranged in parallel at another surface of said common electrode;
a second electrode arranged to sandwich said second sub-pixel organic material layers with said common electrode; and
a third electrode arranged to sandwich said third sub-pixel organic material layers with said common electrode.

15. The full-OEL display panel of claim 14, the second sub-pixel organic layers in the full-color OEL pixel device abuts the second sub-pixel organic layers in its adjacent the full-color OEL pixel device, the third sub-pixel organic layers in the full-color OEL pixel device abuts the third sub-pixel organic layers in its adjacent the full-color OEL pixel device.

16. The full-OEL display panel of claim 14, the second sub-pixel organic layers in the full-color OEL pixel device abuts the third sub-pixel organic layers in its adjacent the full-color OEL pixel device, the third sub-pixel organic layers in the full-color OEL pixel device abuts the second sub-pixel organic layers in its adjacent the full-color OEL pixel device.

17. The full-color OEL display panel of claim 14, wherein said common electrode is a semi-transparent electrode.

18. The full-color OEL display panel of claim 14, wherein said common electrode is selected from a group consisting of a metal, a metal alloy and a metal oxide.

19. The full-color OEL display panel of claim 14, wherein said first electrode is high optically reflective while each of said second and third electrodes is optically transparent.

20. The full-color OEL display panel of claim 19, wherein said first electrode is a metal electrode while each of said second and third electrode is a transparent electrode.

21. The full-color OEL display panel of claim 14, wherein said first electrode is a optically transparent while each of said second and third electrodes is high optically reflective.

22. The full-color OEL display panel of claim 21, wherein said first electrode is a transparent electrode while each of said second and third electrodes is a metal electrode.

23. The full-color OEL display panel of claim 14, wherein said first sub-pixel organic material layers include a suitable combination of elements selected from the group consisting of a hole-injection layer, a hole-transport layer, a light-emission layer, an electron-transport layer and an electron-injection layer.

24. The full-color OEL display panel of claim 14, wherein said second sub-pixel organic material layers include a suitable combination of elements selected from the group consisting of a hole-injection layer, a hole-transport layer, a light-emission layer, an electron-transport layer and an electron-injection layer.

25. The full-color OEL display panel of claim 14, wherein said third sub-pixel organic material layers include a suitable combination of elements selected from the group consisting of a hole-injection layer, a hole-transport layer, a light-emission layer, an electron-transport layer and an electron-injection layer.

26. The full-color OEL display panel of claim 14, wherein said first, second and third sub-pixel organic material layers generate a red light, a green light and a blue light, respectively.
